(19) United States
(12) Patent Application Publication
(10) Pub. No.: US 2004/0211106 A1
(43) Pub. Date: Oct. 28, 2004

(54) Buoyant waterfowl decoy with interchangeable movable appendages

(76) Inventor: Walter Solomon, Marshall, TX (US)

Correspondence Address: D. Scott Hemingway, Law Offices of D. Scott Hemingway, Preston Commons West, Suite 460, 8117 Preston Rd., Dallas, TX, 75225, US

(21) Appl. No.: 10/845,963

(22) Filed: May 14, 2004

Related U.S. Application Data
(63) Continuation of application No. 09/648,930, filed on Aug. 25, 2000.

(51) Int. Cl. A01M 31/06

(52) U.S. Cl. 43/3

(57) ABSTRACT

A waterfowl decoy with positive buoyancy and interchangeable moveable appendages includes a shell-like hollow body with an open bottom. two opposed sides with shaft apertures extending through the two sides in opposed relation to each other, and a buoyant base removeably attached to the bottom of the body; a drive assembly with two battery powered electric motors, each having a rotatable output shaft, disposed in the hollow interior of the body with the output shafts extending through the shaft apertures on each side of the body of the decoy, and a variety of appendage assemblies each removeably connectable to an output shaft of one of the motors.

Each appendage assembly has a hub and at least one appendage such as a wing or paddle appendage connected to the hub, so that upon activation of the motors the hubs rotate and the appendages move to simulate movements of live waterfowl.

### RELATED APPLICATION DATA

This application is a Continuation Application filed under 37 CFR § 1.53(b) of patent application Ser. No. 09/648,930 filed on Aug. 25, 2000, and this application hereby incorporates by reference the earlier filed application.

### TECHNICAL FIELD OF THE INVENTION

The present invention relates to waterfowl decoy devices, and in its preferred embodiments more specifically relates to waterfowl decoy devices with positive buoyancy and interchangeable appendages to selectively provide propulsion, splashing action, and wing movement to simulate the appearance of live waterfowl.

### BACKGROUND OF THE INVENTION

Waterfowl decoys have long been used by hunters in an effort to attract ducks and other waterfowl to a particular body of water or to a particular location in a body of water. Traditionally, such decoys have been inanimate structures that are placed on a body of water and allowed to float passively, without movement of any kind. Although stationary decoys generally simulate the appearance of waterfowl, the absence of movement severely limits their effectiveness in attracting waterfowl.

Attempts have been made in the past to overcome the problems associated with stationary decoys, and decoys that exhibit various forms of motion are known in the prior art. For example, U.S. Pat. No. 2,799,960 to Riley discloses a decoy with a motor driven propeller and movable head. Other examples of propeller driven decoys include U.S. Pat. No. 2,814,146 to Propp, U.S. Pat. No. 2,835,06410 Webb U.S. Pat. No. 3,074,195 to Vanderpool, and U.S. Pat. No. 3,000,128 to McAda. U.S. Pat. No. 2,443,040 to Jones and U.S. Pat. No. 2,704,416 to Laird disclose decoys with fully submerged paddle mechanisms to impart movement to a decoy. Other examples include U.S. Pat. No. 2,747,314 to McGregor, which discloses a decoy apparatus with movable wings and head; U.S. Pat. No. 2,480,390, which discloses a decoy with movable wings; U.S. Pat. No. 4,896,448, which discloses a decoy with movable wings; and British Patent No. 383031, which discloses a bird decoy with movable wings.

The efforts known in the prior art relating to floating decoys have been effective in producing one or more forms of motion, but have generally been much less effective in producing lifelike motion and imparting a realistic appearance to decoys, and in producing water movement around the decoys. Accordingly, they have been only marginally successful in providing the desired effect of attracting waterfowl. Many of the apparatus designs known in the prior art are complex in structure, adding to the cost of production and to the difficulty of use. Floating decoys with a body structure having a closed lower hull, that provide any form of movement or propulsion may pose an additional problem. Such decoys typically include an access opening in the body of the decoy, and various openings for a drive shaft or the like, and do not prevent water from entering the body through those openings. During operation of the decoy water accumulates in the body, causing the decoy to sink lower and lower in the water until the decoy finally sinks.

Some decoys, often utilizing rotating wings, are mounted on poles so that the decoy is elevated above the surface of a body of water or on land. Pole mounted decoys of the prior art are not adapted for use as floating decoys and are not suitable for that purpose. Conversely, floating decoys known in the prior art are not adapted for use as pole mounted decoys and are not suitable for that purpose.

There remains a need for decoy apparatus that produces wing and/or paddle movement to realistically simulate the appearance of live waterfowl, that allows the same decoy body and drive mechanism to be used to produce a variety of movements, that will not sink during use, and that is useable as both a floating decoy and as a pole mounted decoy.

### SUMMARY OF THE INVENTION

The present invention provides a waterfowl decoy that addresses and overcomes the deficiencies and problems of the prior art by producing movement of wing and/or paddle appendages associated with the decoy that realistically simulates live waterfowl wing movement providing propulsion and splashing of the water around the decoy, and by providing a decoy with positive buoyancy to eliminate the problem of water ingress and sinking experienced with some prior art decoys.

The movement exhibited by the decoy of the present invention is produced by a drive apparatus that is simple in structure and operation, inexpensive to produce, and easy to install in a decoy body. The optional simultaneous movement and splashing actions of the decoy are produced by the same drive apparatus. The decoy of the invention is designed to avoid retention of water in the body of the decoy and to maintain positive buoyancy. The decoy may also be readily mounted on a vertical pole, so that the decoy may be used as a floating decoy or as a pole mounted decoy without alteration.

The present invention utilizes a decoy body, generally comprising a body with a hollow interior, a top, two opposing sides, a head end, and a tail end. In the preferred embodiment, a head and neck is rotatably mounted at the head end of the decoy or offset to either side of the axis. The decoy body is formed as a shell, with a fully open bottom providing access to the hollow interior for installation of the drive assembly and for operation of the drive assembly. A removable generally rigid buoyant base is disposed within the body shell at the lower edges thereof to loosely close the majority of the bottom opening, leaving an opening into the interior between the rear of the base and the tail of the decoy.

The base is sufficiently buoyant to support the entire decoy structure and prevent it from sinking, and the opening between the base and the tail allows any water entering the body to freely drain. The base includes a pole aperture extending fully through the base for the insertion of a pole when the decoy is to be used as a pole mounted decoy. The decoy body also has a pair of shaft apertures formed in the opposing sides of the body through which drive shafts extend. The invention can also be used with a more conventional hollow body with an access portal cut into the top of the decoy body

The drive assembly of the preferred embodiment of the present invention includes a pair of drive assemblies, preferably battery powered electric motors, each of which drives a rotary shaft that extends through one of the shaft apertures in the sides of the body of the decoy and to which an appendage assembly is attached. In the preferred embodiment, the output shaft at each motor comprises the drive shaft, and each motor is oriented in the hollow interior of the body with the drive shaft extending toward the adjacent side of the body and through the shaft aperture therein, so that the drive shafts are generally parallel to the surface of the water in which the decoy will float and perpendicular to the longitudinal axis of the decoy.

The shaft apertures are positioned in the sides of the body and the drive assemblies are positioned in the hollow interior of the body, so that the drive shafts are disposed a distance above the surface of the water when the decoy is floating thereon. An appendage assembly, either wing, paddle, or a combination of one or the other, is connected to each drive shaft on the exterior of the decoy body so that rotation of the drive shaft will cause rotation of the appendage assembly and the associated wing and/or paddle appendages

Although the use of two drive motors is preferred, a single motor may be used to drive the two drive shafts, either directly or through a transmission means. The use of dual drive motors is advantageous, especially when the paddle wheel assembly, described below, is used to propel the decoy on the surface of a body of water. Unless the rotation of the paddles is synchronized and the positions of the paddles on each side of the decoy are aligned, paddles on opposite sides of the decoy will be drawn through the water at different times and the uneven application of propulsive force will cause the body of the decoy to “waggle” from side to side, further mimicking movements exhibited by live birds. Because the speed of rotation of the two motors will typically vary slightly, the degree of synchronization of the two paddle wheel assemblies will change during operation of the decoy, and the direction of movement by the decoy will vary over time, enhancing its mimicry of natural waterfowl behavior.

A variety of appendage assemblies may he interchangeably and separably used within the scope of the present invention, and in the preferred embodiment at least a pair of paddle wheel assemblies and a pair of wing assemblies are provided. Those assemblies may he used individually, separately, or in combination on one or more separate assemblies on the same or separate drive shafts. A windmill wing assembly may also be provided, for use with the decoy mounted on a pole. Each of these appendage assemblies includes a hub, adapted to be connected to a drive shaft extending from the decoy, with paddle structures or wing structures connected to the hub. With all but the windmill wing assembly, the decoy may he operated while floating on a body of water or may be mounted on a pole on land or above the surface of the water. Because of the range of movement of the wings of the windmill wing assembly and the need for clearance below the decoy, the windmill wing embodiment is operated with the decoy mounted on a pole. When a paddle wheel assembly is used, rotation of the paddle structures propels the decoy along the surface of the water and simultaneously splashes water toward the tail of the decoy. The wing assembly is intended to visually mimic flapping wings, and the combination of a wing and paddle assembly causes considerable motion and splashing on the surface of the water. The direction of travel can be further controlled and influenced by changing the orientation of the rotatable head and neck.

The structure and features of the preferred and various alternative embodiments of the invention are disclosed with reference to the accompanying drawing figures

### BRIEF DESCRIPTION OF THE DRAWINGS

The objects and features of the invention will become more readily understood from the following detailed description and appended claims when read in conjunction with the accompanying drawings in which like numerals represent like elements and in which:

FIG. 1 is a side view of a decoy of the preferred embodiment of the invention with paddle wheel and rotating wing appendage assemblies;

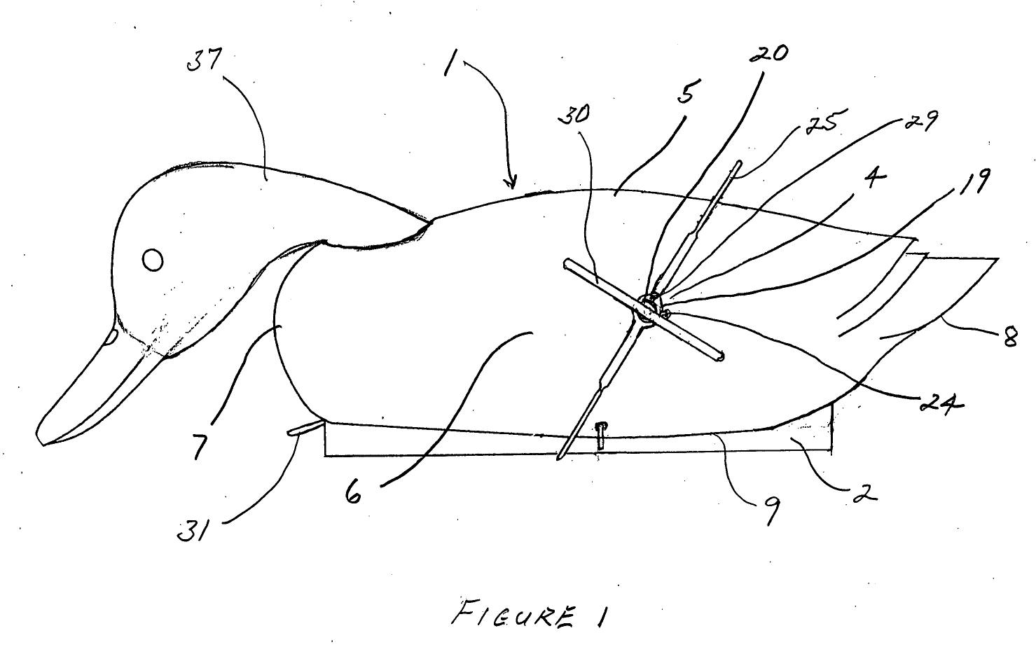

FIG. 2 is a side view of the decoy of the preferred embodiment of the invention, with rotating wing appendage assemblies, mounted on a pole;

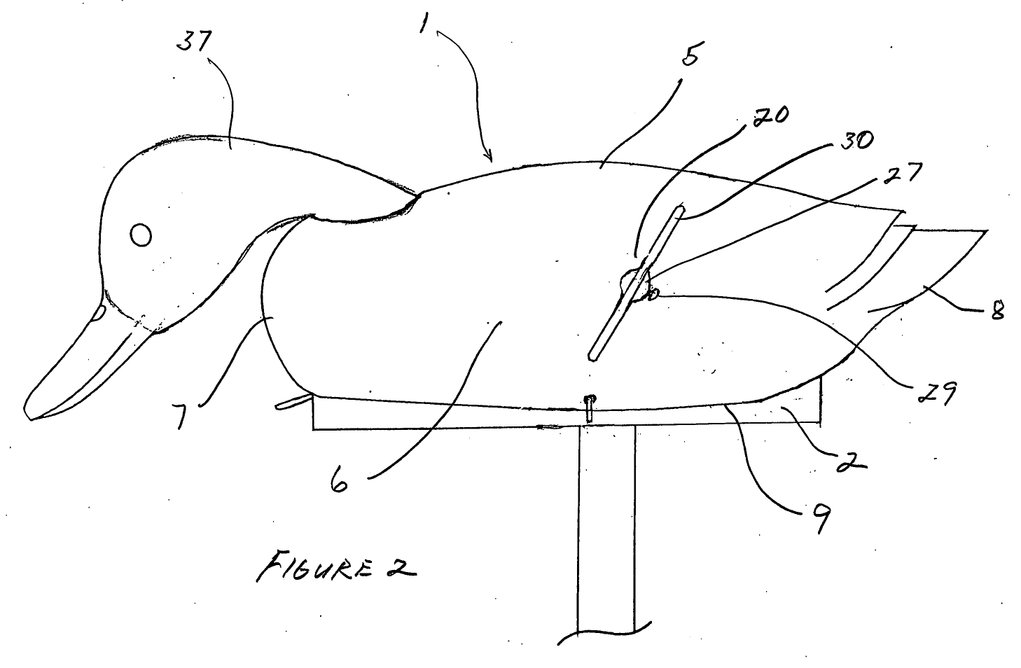

FIG. 3 is a top view of the decoy of the preferred embodiment of the invention, with rotating wing appendage assemblies, with the head and neck oriented for straight ahead movement;

FIG. 4 is a top view of the decoy of the preferred embodiment of the invention, with combined paddle wheel and rotating wing appendage assemblies, with the head and neck oriented for curving movement to the right;

FIG. 5 is a top view of a decoy of the preferred embodiment of the invention, with paddle wheel appendage assemblies, with the head and neck oriented for curving movement to the left;

FIG. 6 is a bottom view of the preferred embodiment of the body of the decoy, with the buoyant base in place;

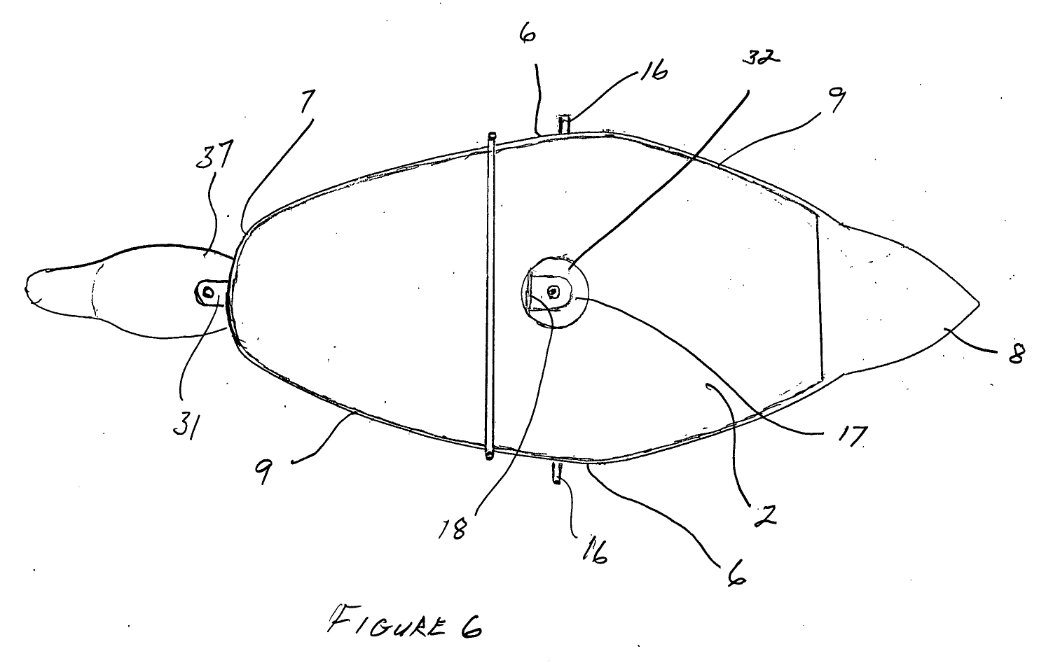

FIG. 7 is a bottom view of the preferred embodiment of the invention, with the buoyant base removed to show the drive mechanism.

FIG. 8 is a cross-sectional view of the preferred embodiment of the decoy of the invention with paddle wheel appendage assemblies, along line 8-8 of FIG. 5; with the buoyant base removed.

FIG. 9 is a cross-sectional view of the preferred embodiment of the decoy of the invention with paddle wheel appendage assemblies, as in FIG. 8, with the buoyant base in place;

FIG. 10 is a side view of a paddle wheel assembly and a rotating wing assembly, in separated relation, illustrating the preferred structure and the preferred manner of attachment;

FIG. 11 is a side view of an alternative embodiment of the paddle wheel assembly; and

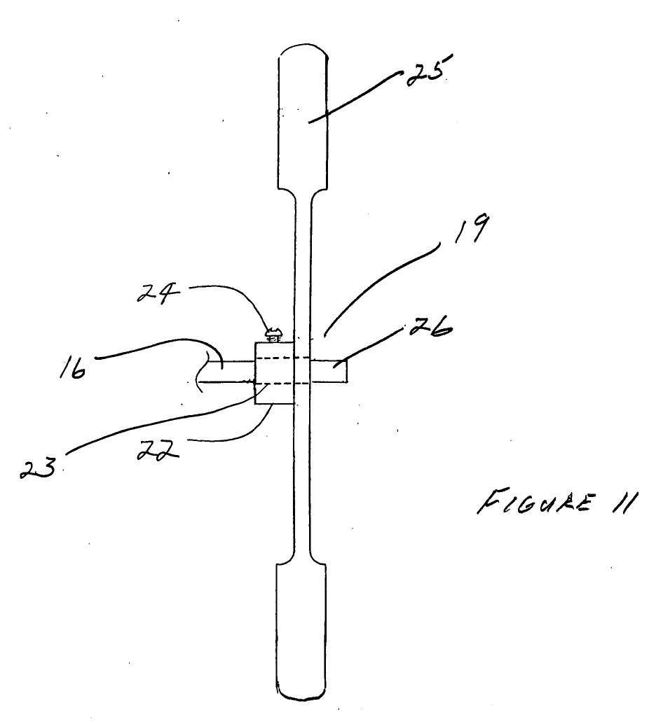

FIG. 12 is a side view of a windmill wing assembly.

### DETAILED DESCRIPTION OF THE PREFERRED EMBODIMENTS

With reference to the drawing figures, the preferred embodiment of the decoy of the invention generally includes a hollow decoy body shell 1, a buoyant base 2, a drive assembly 3, and a pair of appendage assemblies 4

The apparatus of the invention utilizes a waterfowl decoy body formed as a shell with a hollow interior and a fully open bottom. Body 1 includes a top 5, opposing sides 6, a head end or forward end 7, and a tail end 8. The body shell 1 has a lower edge 9 at the open bottom. A shaft aperture 10 is provided in each side 6 of the body 1, near the midpoint thereof to receive a drive shaft. Buoyant base 2 is removably disposed at the bottom of the body shell, with its sides generally adjacent to lower edge 9 at the forward end 7 and sides 6 of the body 1. Base 2 extends through the majority of the length of the body 1 from the forward end 7 to the tail end 8, but ends short of the tail to leave an opening into the interior of the body 1 above the base at the tail end 8. Base 2 is formed in a planar configuration, preferably of a relatively rigid, highly buoyant closed cell foam material. In another embodiment, the body 1 has a conventional closed bottom with an access portal or flap cut through the top 5 of the decoy body 1.

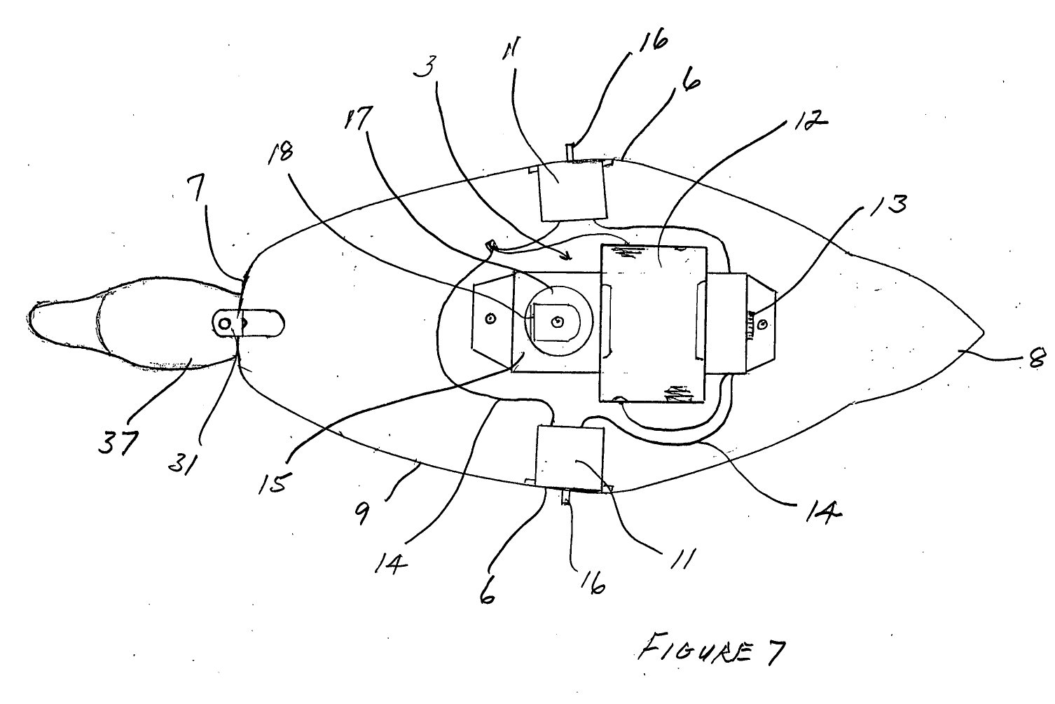

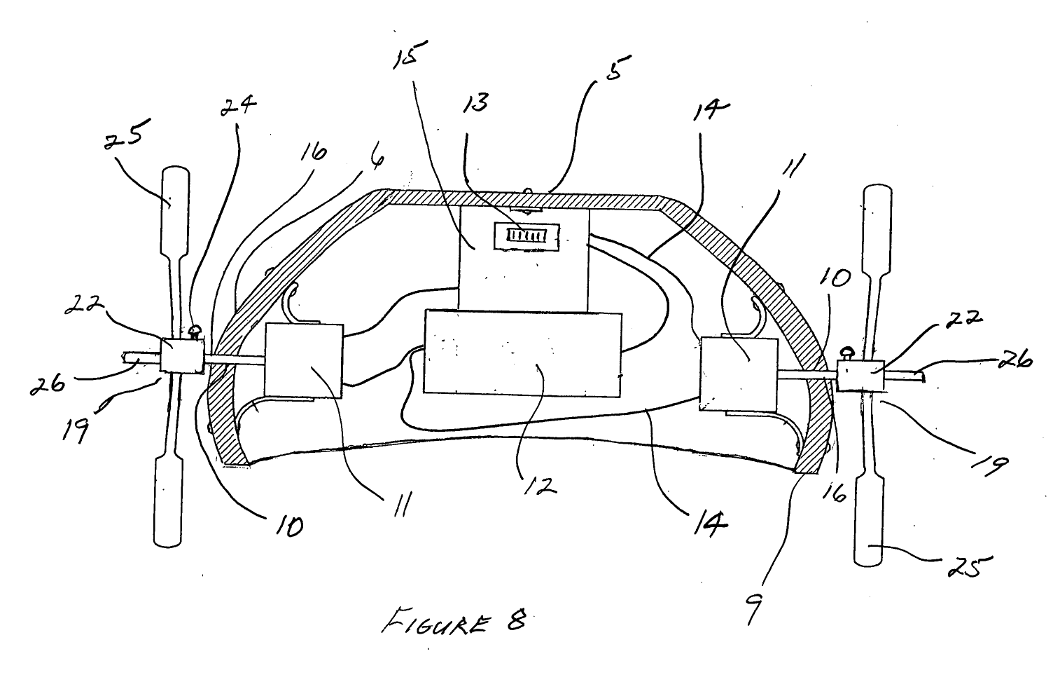

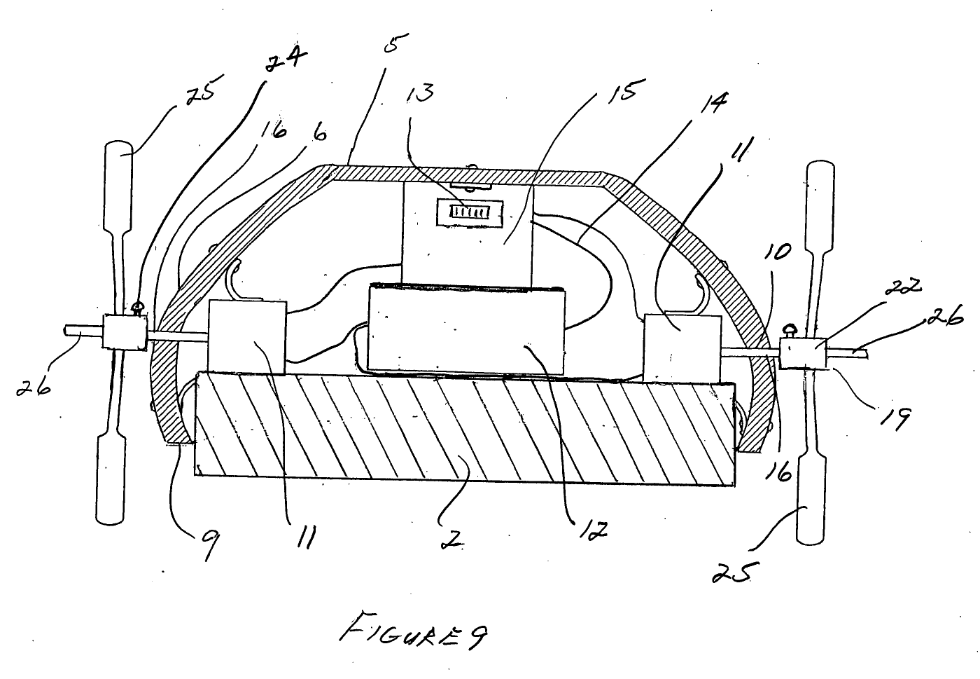

In the preferred embodiment of the invention, drive assembly 3 generally includes a pair of battery powered electric motors 11, a battery holder 12 with switch 13, associated wiring 14, and a mounting bracket 15 for the battery holder 12 and switch 13. Each motor 11, which is preferably sealed for water resistance, includes an output shaft 16, which rotates when electrical power is applied to the motor 11. Each motor 11 preferably comprises a commercial direct current (DC) electric motor that will operate at approximately 250 rpm at 1.5 volts and at approximately 300 rpm at 3.0 volts. Switch 13 is preferably a variable resistance switch that is manually adjustable to supply between 1.5 volts and 3.0 volts to the motors for the purpose of adjusting the speed of the motors between about 250 rpm and about 500 rpm. Each motor 11 is secured to a respective side 6 of body 1 by rivets or other convenient means, with output shaft 16 extending through a shaft aperture 10 to the exterior of body 1. The output shafts 16 function directly as drive shafts to which appendage assemblies 4 are connected. It is preferred that motors 11 he connected directly to the body shell 1, as shown in FIG. 7, but mounting brackets, such as those shown in FIGS. 8 and 9, may be used, if desired. A gasket or other sealing means is provided around each output shaft 16 to prevent water from entering the interior of the motor 11 through the opening in the motor housing through which the output shaft 16 extends. Although the use of dual drive motors is I preferred, the invention is not necessarily limited to that arrangement, and a single motor could he used to drive the two drive shafts 16, if desired.

Battery holder 12 and switch 13 are secured to mounting bracket 15, which is disposed in the interior of body 1 and connected to the body 1 by rivets or other convenient means. Battery holder 12 includes positive and negative contacts connected to switch 13 and motors 11 by wiring 14. Mourning bracket 15 is preferably made from corrosion-resistant aluminum and is shaped to accommodate the components of the drive assembly attached to it and to position the battery holder 12 and switch 13 to facilitate access to them with the drive assembly installed in the body 1 of the decoy. In the preferred embodiment, battery holder 12 is selected to receive two 1.5 volt D cell batteries, in series. As illustrated in FIG. 7, mounting bracket 15 includes a pole aperture 17 with a pole retainer tab 18 to receive and frictionally retain one end of a mounting pole.

It should be understood that while the disclosed motor rotational speed and operating voltage ranges are preferred, the invention is not limited to those ranges, and other ranges and even alternative drive means may be used within the scope of the invention. Battery holder 12 could, alternatively, be sized to hold a single 1.5 volt battery, and a simple on-off switch could be used in place of the variable speed switch. Switch 13 could he omitted entirely, so that motors 11 are activated by insertion of a battery or batteries into the battery holder 12 and deactivated by removal of the battery. In a further alternative embodiment for controlling the operation of the motors, an interrupter relay or other circuit component may be associated with switch 13, or used in place thereof. The relay, if used, will intermittently interrupt the flow of electrical power from the battery to the motors 11, resulting in intermittent movement of the appendage assemblies 4 instead of continuous movement.

The drive assembly of the decoy operates the appendage assemblies 4 to impart motion to the decoy. A variety of appendage assemblies 4 may be connected, interchangeably and in combination, at the discretion of the user. Preferred appendage assemblies include a paddle wheel or foot assembly 19 and a rotating wing assembly 20, which may be used with the decoy 1 floating on the surface of a body of water or mounted on a pole, and a windmill wing assembly 21, which may be used with the decoy 1 mounted on a pole.

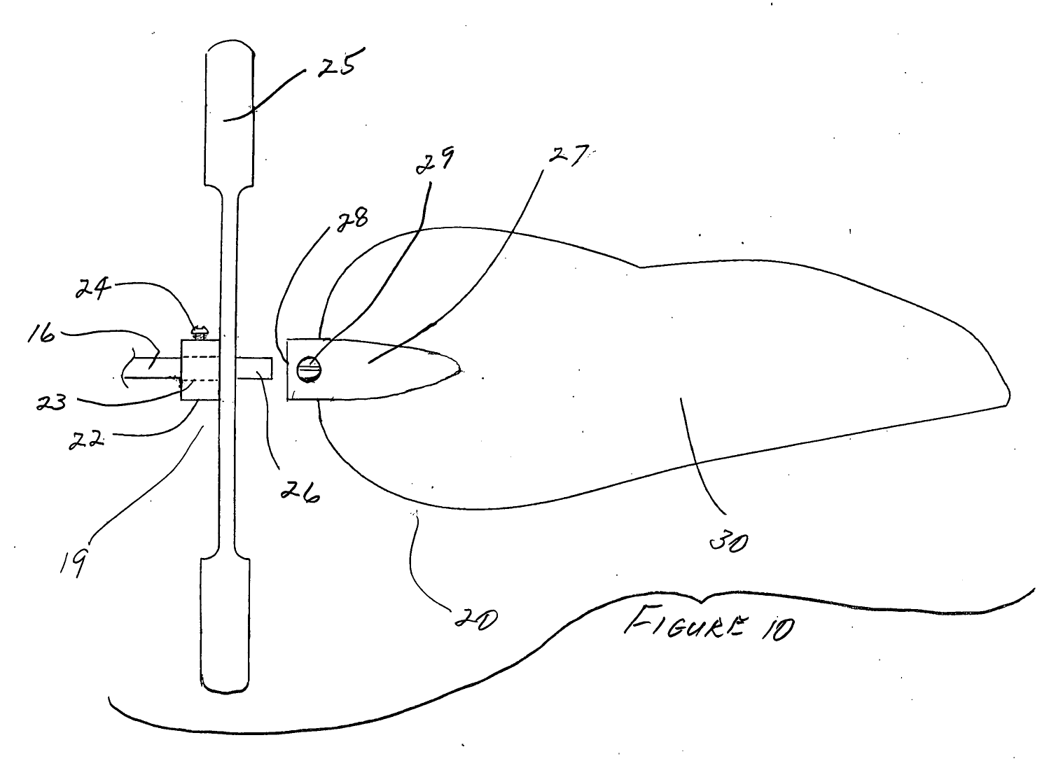

In the preferred embodiment, each paddle wheel assembly 19, illustrated in FIG. 10, includes a hub 22 with a central hub aperture 23 to receive a drive shaft. Connection is preferably an adjustable set screw 24 in hub 22 to selectively grip a drive shaft 16 and removably connect the paddle appendage assembly 19 to the drive shaft 16. Two paddles 25 are connected in opposing relation to each other and extend outwardly from the hub 22 in generally perpendicular relation to the axis of the hub aperture 23. It should be understood that while the two paddle configuration is preferred, three or more paddles, or a single paddle, could he used if desired.

In the preferred embodiment, the paddles 25 are integrally formed as a single piece, which includes the hub 22. The end of the paddles 25 are paddle structures that may be (1) flat, elongated appendages, (2) flat, oval-shaped appendages, or (3) flat, circular appendages. These structures may also be integrated into the paddle 25 itself or may be removable structures. Combinations of wing and different foot paddles may be used, and even used alternatively, on different moving wing or paddle struts or axles of the decoy.

Each paddle 25, whether elongated, oval, or circular, is of sufficient length such that a portion of the paddle structure will extend below the surface of the water when the appendage assembly 19 is connected to and rotated by the drive shafts 16 with the decoy 1 floating on the water surface. When the drive motor 11 is activated the hubs 22 rotate, driving the paddles 25 through the water and propelling the decoy 1 along the surface of the water. In addition to propelling the decoy 1 in the water, the rotation of the paddles 25 through the water causes water to be splashed toward the rear, or tail end 8, of the decoy 1 as long as the drive motor 11 is activated, providing a further attractive aspect to the decoy.

In the preferred embodiment, each paddle wheel assembly 19 includes an extension shaft 26, extending outwardly in coaxial alignment with the hub aperture 23, to facilitate attachment of a wing assembly 20 in combination with the paddle wheel assembly 19. The paddles 25 and associated hub 22 may also be separately formed and connected in any convenient manner. The shaft 16 may extend completely through the body of the hub 22 so that a wing assembly 20 may be attached. A foot paddle 25 may alternatively be coupled to, or integrated with, any one of the hubs 22.

Each rotating wing assembly 20, shown in FIG. 10, includes a hub 27 with a hub aperture 28 and set screw 29 for connection of the hub 27 to a drive shaft 16 or to an extension shaft 26. A single wing 30 connected to its hub 27 and extending outwardly therefrom with the longitudinal axis of the wing 30 generally parallel to the axis of hub aperture 28 and shaft 16 or shaft extension 26. In the preferred embodiment, each wing 30 comprises an elongated generally planar body formed with the general configuration and appearance of a waterfowl wing. Each wing 30 is integrally formed with its associated hub 27, but it should be understood that the wings 30 and hubs 27 may be separately formed and separately connected in any convenient manner.

The wing 30 and paddle 25 appendages may also be part of a single hub 22 or separately connected upon a drive shaft 16 using two hubs 22 and 27. A foot paddle 25 may alternatively be coupled to, or integrated with, any one of the hubs 22. When a pair of the rotating wing appendage assemblies 30 connected to the drive shafts 16 extending from the body of the decoy and the drive motors 11 are activated, the wings 30 rotate around their longitudinal axes and mimic the appearance of a live bird flapping its wings. The flapping appearance may be enhanced by coloring one side of each wing 30 a light color and the opposite side a dark color. The width of wing 30 is preferably less than twice the distance from the drive shafts 16 extending from the body 1 of the decoy to the surface of the water on which the decoy is placed to float, so that as wings 30 rotate the edges of the wings 30 remain above the surface of the water. However, if desired, the width of the wings 30 may he selected so that a portion of the wing 30 will enter the water as the wing 30 rotates and splash water from the surface as each edge of the wing 30 leaves the water.

As noted above, the paddle wheel assemblies 19 and the rotating wing assemblies 20 may be used separately, or in combination, in any convenient manner as desired. When used separately the hub 22 or 27 of each appendage assembly 19 or 30 is connected to a drive shaft 16, with the shaft extending into the hub aperture 23 or 28, and the set screws 24 or 29 tightened to retain the two separate assemblies in place.

When used in combination, the paddle wheel assemblies 19 are connected directly to drive shafts 16 and the rotating wing assemblies 20 are connected to the paddle wheel assemblies 19, by connecting hubs 27 to shaft extensions 26. Alternatively, the shaft 16 can extend completely through the hub 22 so that both a paddle assembly 19 or wing assembly 20 can be attached to shaft 16, or any combination of both paddle assembly 19 and wing assembly 20 may be so attached. Upon activation of the drive motor 11 the paddles 25 and wings 30 rotate together or in a combination of the movements described above, propelling the decoy along the surface of the water, splashing water around the decoy, and mimicking the appearance of flapping wings and paddling feet. When the decoy is prepared for use with the desired appendage assemblies attached, the drive motor 11 is activated and the decoy 1 is placed in the water.

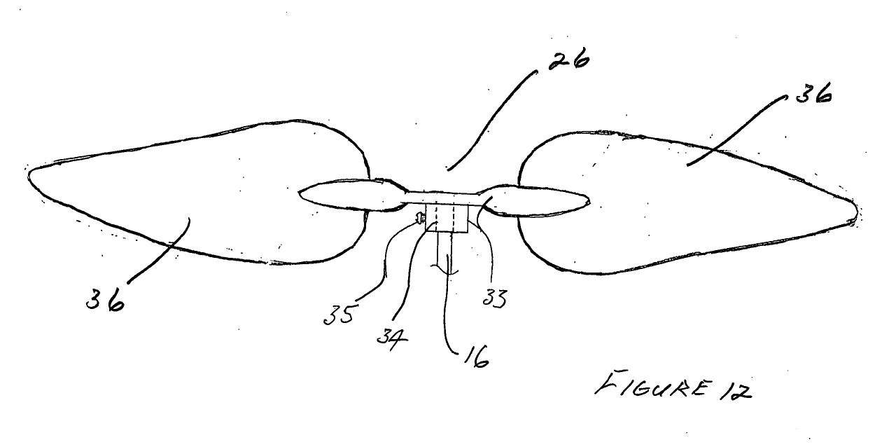

In another embodiment, a wing assembly 20 and a paddle assembly 19 could be placed on separate drive shafts 16 or moving struts to mimic waterfowl movement and water splashing. An anchor tab 31 is provided in the preferred embodiment so that the decoy 1 can be anchored with an anchor line of desired length to restrain its range of movement and facilitate retrieval. Alternatively, the decoy 1 may be mounted on a pole to elevate it above the surface of the water or position it on land, by inserting one end of a mounting pole through an aperture 32 in base 2 and into aligned aperture 17 in mounting bracket 15, where it is frictionally retained by pole tab retainer tab 18. If the decoy 1 is to he mounted on a pole for use, windmill wing assemblies 26 shown in FIG. 12 may be connected to drive shafts 16, if desired, to provide an alternative form of motion.

Like the other two appendage assemblies, each windmill wing assembly 26 of FIG. 12 includes a hub 33, with a central aperture 34 and a set screw 35, and two wings 36. Unlike the rotating wing assembly 20, the windmill wing assembly 26 includes a pair of wings 36, connected opposite to each other on hub 33 with their longitudinal axes perpendicular to the axis of aperture 34. Since the wings 36 extend outwardly from the axis of rotation, they rotate in a windmill fashion.

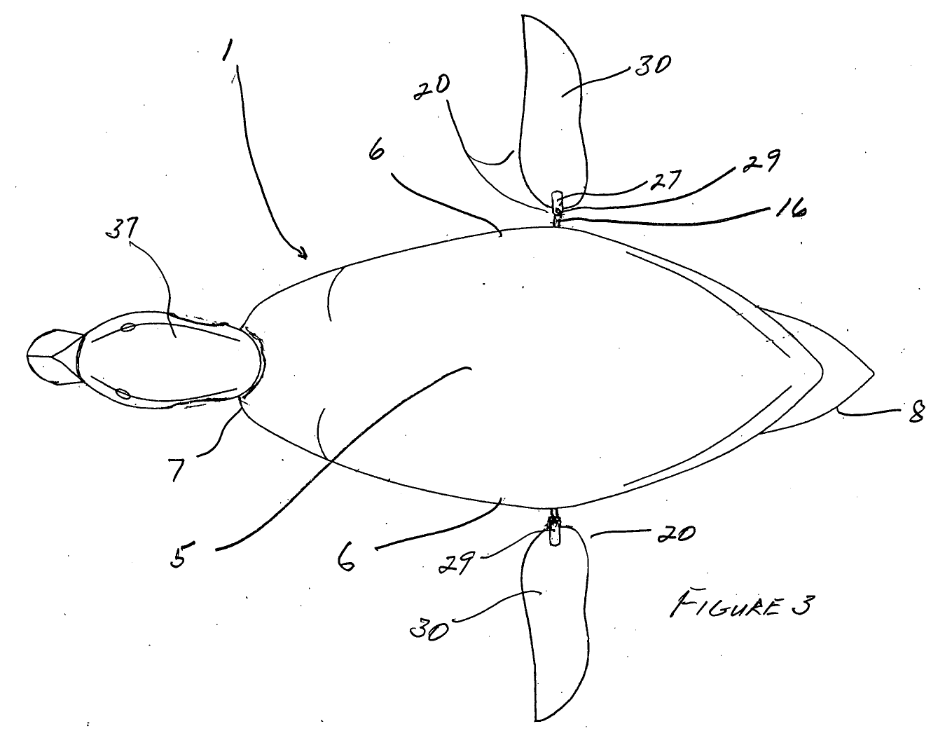

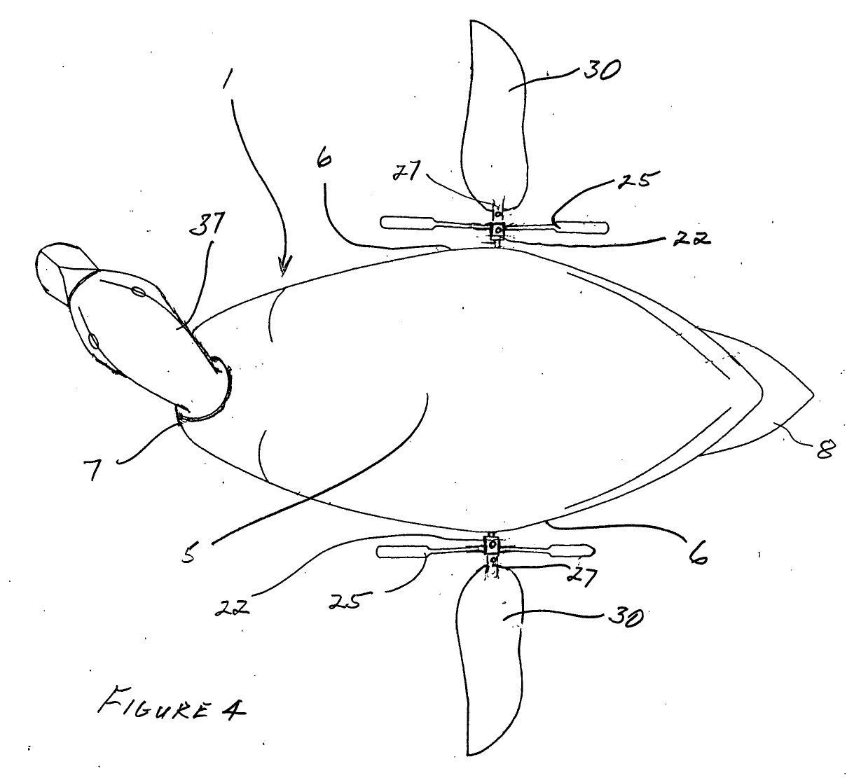

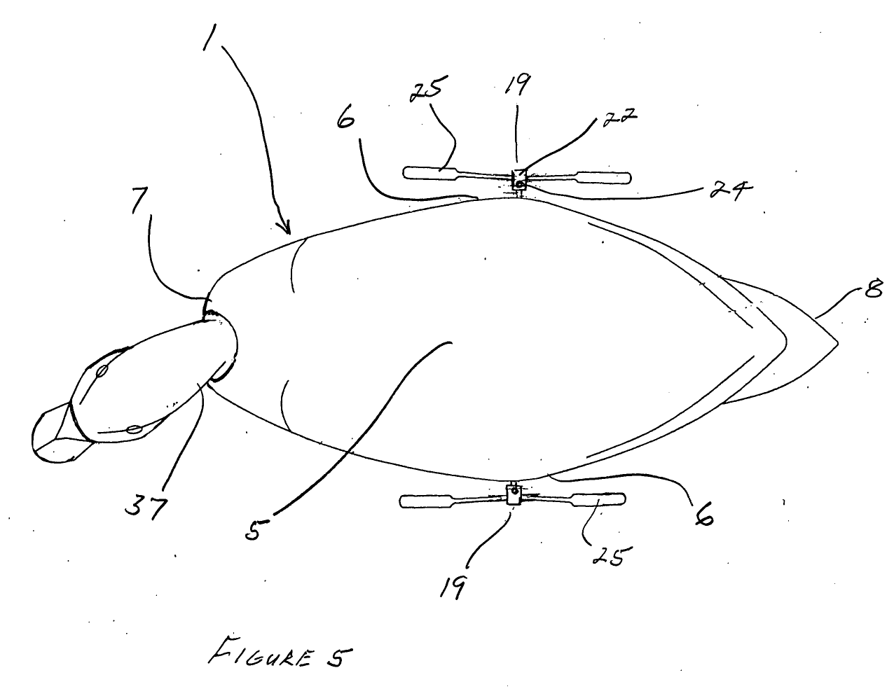

When paddle wheel assemblies 19 are used, with or without rotating wing assemblies 20, to propel the decoy 1 along the surface of a body of water, head and neck member 37, which is pivotally connected to the top 5 of the body 1 at its forward end 7, provides steering ability. When the head and neck member 37 is aligned with the longitudinal axis of the body, as in FIG. 3, the direction of travel is generally straight. However, rotation of the head and neck member 37 to either side, as in FIGS. 4 and 5, shifts the weight balance to cause the decoy to follow a curved path.

The foregoing description of the preferred embodiments and certain alternative embodiments of the invention is intended to be illustrative and not limiting. The invention is susceptible to further alternative embodiments and variations in design and in use, all within the scope of the invention as disclosed and claimed.

1. A buoyant waterfowl decoy with moveable appendages, comprising:
a body with a longitudinal axis, a forward end, a tail end, a top, two opposing sides, a hollow interior and an open bottom, said body having a pair of shaft apertures formed in said sides of said body in opposed relation across said longitudinal axis of said body;
a buoyant base disposed within said open bottom of said body and removably connected to said body, said base extending between said two opposing sides of said body and from said forward end of said body a majority of the distance toward said tail end;
a drive assembly disposed in said hollow interior of said body, said drive assembly including a pair of motors each having a rotatable drive shaft each extending through a respective one of said shaft apertures in said sides of said body from said interior to the exterior thereof; and
a pair of appendage assemblies, each having a hub, a hub aperture in said hub to receive one of said drive shafts therein so as to removably connect said hub to said drive shaft, and at least one appendage connected to and extending outwardly from said hub, each of said appendage assemblies removably connectable to a separate one of said drive shafts.

2. The buoyant waterfowl decoy of claim 1, wherein said drive assembly further comprises switch means for selectively activating and deactivating said motors.

3. The buoyant waterfowl decoy of claim 2, wherein said motors are battery powered electrical motors, wherein said drive assembly further includes a battery holder to receive a battery for actuating said motors, and wherein said drive assembly further includes electrical wiring connected between said battery holder and said motors through said switch means, such that said motors are activated when a battery is placed in said battery holder and said switch is operated to conduct electrical current therethrough and said motors are deactivated when said switch is operated to interrupt the flow of electrical current.

4. The buoyant waterfowl decoy of claim 2, wherein said switch means comprises a variable resistance switch for additionally selectively controlling the speed of said motors.

5. The buoyant waterfowl decoy of claim 3, wherein said switch means includes automatic interrupter means for temporarily interrupting the flow of electrical current through said wiring so as to intermittently interrupt the activation of said motors when said switch is operated to conduct electrical current.

6. The buoyant waterfowl decoy of claim 1, wherein said at least one appendage comprises a pair of elongate paddles connected to said hub in generally opposing relation and extending from said hub such that said paddles are disposed generally perpendicular to said drive shaft when said hub is connected thereto.

7. The buoyant waterfowl decoy of claim 6, wherein said an elongate paddles are integrally formed as a unitary structure connected to said hub.

8. The buoyant waterfowl decoy of claim 6, wherein said hub includes an extension shaft extending from said hub opposite and in coaxial alignment with said hub aperture.

9. The buoyant waterfowl decoy of claim 1, wherein said at least one appendage comprises an elongate wing having a longitudinal axis, connected to said hub and extending from said hub such that said longitudinal axis of said wing is generally parallel to said drive shaft when said hub is connected thereto.

10. The buoyant waterfowl decoy of claim 1, wherein said at least one appendage comprises a pair of elongate wings each having a longitudinal axis, connected to said hub in generally opposing relation and extending from said hub such that said longitudinal axes of said wings are generally perpendicular to said drive shaft with said hub is connected thereto.

11. The buoyant waterfowl decoy of claim 1 wherein said buoyant base comprises a generally planar board formed of a closed cell foam material.

12. The buoyant waterfowl decoy of claim 1, wherein said drive assembly includes a mounting bracket disposed in said hollow interior of said body and connected to said body, said mounting bracket includes a pole aperture to receive one end of a mounting pole therethrough, and wherein said buoyant base includes a base aperture coaxially aligned with said pole aperture of said mounting bracket to receive a mounting pole therethrough.

13. The buoyant waterfowl decoy of claim 1, wherein said body further includes a head and neck member pivotally connected to said top of said body near said forward end thereof.

14. A buoyant waterfowl decoy with interchangeable moveable appendages, comprising:
a body with a longitudinal axis, a forward end, a tail end, a top, two opposing sides, and a hollow interior, said body having a pair of shaft apertures formed in said sides of said body in opposed relation across said longitudinal axis of said body:
a drive assembly including motor means disposed in said hollow interior of said body, and a pair of rotatable drive shafts driven by said motor means, said drive shafts extending from said interior of said body through said respective shaft apertures with a portion of each of said drive shafts extending outwardly from a respective one of said sides of said body;
buoyancy means associated with said body for providing positive buoyancy to said decoy so as to prevent said decoy from sinking below the surface of a body of water with said decoy disposed in said body of water; and
a plurality of appendage assemblies, each having a hub, a hub aperture in said hub to receive one of said drive shafts therethrough so as to releasably connect said hub to said drive shaft, and each having at least one appendage, each of said appendages connected to and extending outwardly from said hub, and each of said appendage assemblies removably connectable to a separate one of said drive shafts such that said appendage assemblies are caused to rotate upon rotation of said drive shafts with said appendage assembly connected thereto.

15. The buoyant waterfowl decoy of claim 14, wherein said motor means comprises a pair of motors, each having a rotatable output shaft, said motors disposed in said hollow interior of said body with said output shaft of each of said motors extending through a different one of said shaft apertures in said body, and wherein said output shafts of said motors comprise said drive shafts.

16. The buoyant waterfowl decoy of claim 14, wherein said plurality of appendage assemblies comprises a pair of paddle wheel assemblies each having an elongate paddle with first and second ends, connected to said hub between said first and second ends in generally perpendicular relation to the axis of said hub aperture, with said first and second ends extending outwardly from said hub.

17. The buoyant waterfowl decoy of claim 14 wherein said plurality of appendage assemblies comprises a pair of rotating wing assemblies each having an elongate wing with first and second ends and a longitudinal axis, connected to said hub at said first end and extending outwardly from said hub with said longitudinal axis of said wing generally parallel to the axis of said hub aperture.

18. The buoyant waterfowl decoy of claim 16, wherein said hub of said paddle wheel assembly includes an extension shaft extending outwardly from said hub of said paddle wheel assembly opposite said hub aperture of said paddle wheel assembly in coaxial alignment therewith, and wherein said plurality of appendage assemblies further comprises a pair of rotating wing assemblies, each having an elongate wing with first and second ends and a longitudinal axis, connected to said hub of said wing assembly at first end and extending outwardly from said hub of said wing assembly with said longitudinal axis of said wing generally parallel to the axis of said hub aperture of said wing assembly, with each said wing assemblies being removably connectable to said extension shaft of one of said paddle wheel assemblies.

19. The buoyant waterfowl decoy of claim 14, wherein said body has an open bottom and a lower edge extending around said open bottom, and wherein said buoyancy means comprises a buoyant base disposed within said open bottom of said body adjacent to said lower edge and removably connected to said body, said base extending between said two opposing sides of said body and from said forward end of said body a majority of the distance toward said tail end, with an open passageway said tail end of said body and said buoyant base for the egress of water from said hollow interior of said body through said passageway.

20. The buoyant waterfowl decoy of claim 16, wherein said decoy is propelled along the surface of the water by rotation of said paddle wheel assemblies, wherein said body further includes steering means comprising a head and neck member pivotally connected to said top of said body near said forward end thereof such that said head and neck member may be turned from side to side relative to said longitudinal axis of said body.

21. A waterfowl decoy, comprising:
a body portion with a longitudinal axis, a forward end, a tail end, a top, a bottom, a first side, a second side, and a hollow interior;
at least one drive assembly within the decoy body, said drive assembly coupled to one or more drive shafts; and
a first wing appendage having a longitudinal axis that extends in proximate relation to the length of said appendage, said first appendage located in proximate relation to the first side of the decoy body and coupled to the drive assembly and one of said drive shafts so as to provide circular rotational motion of the first appendage around its longitudinal axis when the drive assembly is activated.

22. The waterfowl decoy of claim 21 wherein the bottom is composed of a buoyant base having sufficient buoyancy to float the decoy.

23. The waterfowl decoy of claim 22 wherein the buoyant base is removable and provides access to the interior of the decoy.

24. The waterfowl decoy of claim 22 wherein the buoyant base is composed of a closed cell foam material.

25. The waterfowl decoy of claim 21 further comprising a second wing appendage having a longitudinal axis that extends in proximate relation to the length of said appendage, said second appendage located in proximate relation to the second side of the decoy body and attached to the drive assembly and one of said drive shafts so as to provide circular rotational motion of the second appendage around its longitudinal axis when the drive assembly is activated.

26. The waterfowl decoy of claim 21 wherein the drive assembly drives a single shaft.

27. The waterfowl decoy of claim 21 wherein the drive assembly drives separate first drive shaft and second drive shaft.

28. The waterfowl decoy of claim 25 wherein the drive assembly is composed of two separate motors each driving first and second drive shafts.

29. The waterfowl decoy of claim 25 wherein the buoyant base is removable.

30. The waterfowl decoy of claim 29 wherein the buoyant base provides access to the interior of the decoy.

31. The waterfowl decoy of claim 21 further comprising a first foot paddle appendage.

32. The waterfowl decoy of claim 31 further comprising a second foot paddle appendage.

33. The waterfowl decoy of claim 21 wherein the bottom has an aperture for mounting onto a pole.

34. The waterfowl decoy of claim 21 wherein the drive assembly speed is adjustable.

35. The waterfowl decoy of claim 21 wherein the drive assembly operation is interruptible.

36. A waterfowl decoy comprising:
a body portion with a longitudinal axis, a forward end, a tail end, a top, a bottom, a first side, a second side, a hollow interior;
a drive assembly located in said hollow interior;
one or more drive shafts coupled to said drive assembly and driven by said drive assembly; and
a first appendage and a second appendage, each circularly rotating around the longitudinal axis of said appendage when the drive shaft rotates.

37. The waterfowl decoy of claim 36 wherein the drive mechanism is one or more electric motors.

38. The waterfowl decoy of claim 36 wherein said first and second appendage is an elongated wing structure coupled to the drive shaft.

39. The waterfowl decoy of claim 36 wherein said first and second appendage is a foot paddle structure coupled to the drive shaft.

40. The waterfowl decoy of claim 36 wherein said appendage is either a wing appendage or a foot appendage.

41. The waterfowl decoy of claim 36 wherein said drive shaft is an opposed single shaft driven by an electric motor.

42. The waterfowl decoy of claim 36 wherein said drive shaft is one or more shafts.

43. The waterfowl decoy of claim 36 wherein said drive mechanism speed is adjustable.

44. The waterfowl decoy of claim 36 wherein said drive mechanism operation is interruptible.

45. A method for imparting movement to a waterfowl decoy, comprising the steps of:
providing a waterfowl decoy with a hollow body, a head end, a tail end, a top, a first side and a second side, and a bottom, with a longitudinal axis running from the head end to the tail end;
providing at least one drive mechanism inside the hollow body of the decoy driving one or more rotating drive shafts;
providing at least one wing appendage with a longitudinal axis extending the length of the wing appendage coupled to said drive assembly and one of said one or more drive shafts; and
moving the wing appendage coupled to said one or more drive shafts to rotate around said longitudinal axis of the wing appendage.

46. The method for imparting movement to a waterfowl decoy of claim 45 further comprising the steps of:
providing a foot paddle appendage attached to a rotating drive shaft; and
moving the foot paddle appendage.

47. The method for imparting movement to a waterfowl decoy of claim 45 wherein at least one appendage is attached to the rotating drive shaft using an appendage assembly.

48. The method for imparting movement to a waterfowl decoy of claim 45 wherein the wing and the foot paddle appendage are attached to the one or more rotating drive shafts using an appendage assembly.

49. The method of imparting movement to a waterfowl decoy of claim 45 wherein the drive mechanism is an electric motor.

50. The method of imparting movement to a waterfowl decoy of claim 45 wherein the one or more drive shaft includes a rotatable shaft extending from the drive mechanism coupled to at least one rotating appendage on the first side or the second side.

51. The method of imparting movement to a waterfowl decoy of claim 45 wherein the rotating shaft is a single axle assembly.

52. The method of imparting movement to a waterfowl decoy of claim 45 wherein the rotating shaft includes two shafts.

53. The method of imparting movement to a waterfowl decoy of claim 45 wherein a removable buoyant base provides access to the interior of the hollow decoy body.
